(19) United States
(12) Patent Application Publication
(10) Pub. No.: US 2025/0289668 A1
(43) Pub. Date: Sep. 18, 2025

(54) Conveyor Drive System

(71) Applicant: ABB Schweiz AG, Baden (CH)

(72) Inventors: Ulf Richter, Cottbus (DE); Jakub Salamoun, Vratimov (CZ); Radim Capla, Ostrava (CZ)

(21) Appl. No.: 18/860,852

(22) PCT Filed: Apr. 29, 2022
(86) PCT No.: PCT/EP2022/061478

§ 371 Date: Oct. 28, 2024

(51) Int. Cl. B65G 23/22

(52) U.S. Cl. CPC B65G 23/22; B65G 2812/02148

(57) ABSTRACT

A conveyor drive system for an industrial conveyor installation including a pulley shaft; a gearless motor including a motor shaft and a motor housing having a mounting section; a base frame for supporting the motor; a first alignment portion; a support structure; a second alignment portion; a connecting portion connecting the base frame to the second support member; and a coupling gearlessly coupling the motor shaft to the pulley shaft and compensating for misalignment between the motor shaft and the pulley shaft.

### TECHNICAL FIELD

The present invention relates to a conveyor drive system, in particular for an industrial conveyor installation, e.g., for mining or other bulk material handling applications, and to a method of installing the same. In particular, the present invention relates to a conveyor drive system having a gearless motor, and a method of installing the same.

### BACKGROUND ART

Conveyor drive systems using gearless motors are known. One type of conveyor drive system using a gearless motor is a conveyor drive system using a shaft-mounted gearless motor, for example, as disclosed in EP 3 767 802 A1. In such a system, the gearless motor is mounted onto the pulley shaft which drives the conveyor belt, such that the pulley shaft supports the gearless motor. In this way, good alignment between the pulley shaft and the gearless motor can be simply and rapidly obtained.

However, in system with shaft-mounted motor, the pulley shaft and its support must be made sufficiently strong to support the motor. In particular, when mounting a gearless motor on an existing conveyor drive system, it may become necessary to modify the existing structure of the drive system, for example by reinforcing the pulley shaft, bearings and other parts of the conveyor installation. This can be time-consuming and costly.

Other conveyor drive systems may use motors installed on a foundation with an integrated steel sole plate interface or on a steel base frame. Because the motor is not mounted on the pulley shaft, alignment of the motor shaft and the pulley shaft becomes critical. The adjustment can be obtained, for example, using permanent and dedicated adjustment provisions, such as a spindle, or eccentric jack points, to adjust the whole frame. An example of such as system is disclosed in EP 2727861 A1.

In such a system, it can be difficult and time-consuming to align the motor shaft with the pulley shaft. However, when installing the drive unit, for example in a mining environment, the alignment may have to be done under unfavorable ambient circumstances and time is generally of critical importance. Therefore, therefore rapid and easy alignment and installation are desirable.

### Problem to be Solved

The present invention was made in view of overcoming the above problems of the prior art. Specifically, the objective of the present invention is to provide a conveyor drive system including a gearless motor, which does not require major modifications of a conveyor installation, and which also allows relatively easy and quick alignment of the gearless motor with the pulley shaft.

### SUMMARY OF INVENTION

The objective of the present invention is achieved by a conveyor drive system, an industrial conveyor installation, and a method of installing a conveyor drive system as described in the claims.

An aspect of the invention is a conveyor drive system for an industrial conveyor installation, the conveyor drive system comprising: a pulley shaft configured to drive a conveyor belt of the conveyor installation; a gearless motor for gearlessly driving the pulley shaft, the motor comprising a motor shaft and a motor housing having a mounting section; a base frame for supporting the motor; a first alignment portion, wherein the motor is mounted with its mounting section on the base frame, the first alignment portion being provided between the mounting section and the base frame for adjusting the motor at least vertically relative to the base frame; a support structure configured for supporting the base frame, the support structure comprising a first support member and a second support member, the first support member and the second support member being spaced apart from each other in a direction perpendicular to an axial direction of the motor shaft; a second alignment portion being provided between the first support member and the base frame for adjusting the base frame at least vertically relative to the first support member; a connecting portion connecting the base frame to the second support member; and a coupling gearlessly coupling the motor shaft to the pulley shaft.

Another aspect of the invention is an industrial conveyor installation having a conveyor belt and a conveyor drive system as described above.

Another aspect of the invention is a method of installing the conveyor drive system of the invention in an industrial conveyor installation, the method comprising the steps of: (a) mounting the support structure comprising the first support member and the second support member to a conveyor installation frame of the conveyor installation; (b) positioning the base frame, with the motor mounted thereon, in alignment with the first support member and connecting the base frame to the second support member by the connecting portion; (c) adjusting the second alignment portion for coarse alignment of the motor shaft with the pulley shaft, and mounting the base frame to the first support member via the second alignment portion; (d) adjusting the first alignment portion for fine alignment of the motor shaft with the pulley shaft; and (e) coupling the motor shaft to the pulley shaft by the coupling.

An advantage of these aspects is that an easy and quick alignment of the gearless motor with the pulley shaft becomes possible, in particular due to the first and second alignment portions and to the coupling between the motor shaft and the pulley shaft. Thereby, the motor shaft can be aligned with the pulley shaft in multiple stages. For example, the second alignment portion, which is provided between the support structure (first support member) and the base frame, can be used for adjusting the base frame, and the motor mounted thereon, relative to the support structure, so that an initial alignment (with an initial tolerance) of the motor shaft with the pulley shaft is achieved. Then, the first alignment portion, which is provided between the motor (mounting section) and the base frame, can be used for adjusting the motor relative to the base frame, so that the alignment of the motor shaft with the pulley shaft is improved, e.g., the tolerance is reduced to a residual tolerance. This reduced residual tolerance—which may also include inevitable load- or temperature-dependent misalignments during operation—may then be sufficiently small to be compensated by the coupling which gearlessly couples the motor shaft to the pulley shaft.

The conveyor drive system of the present invention may be applied to an industrial conveyor installation having a conveyor belt and a conveyor drive system for driving the conveyor belt via the pulley shaft. It may be applied to a heavy-duty conveyor installation, preferably a mining conveyor installation, or a mining conveyor system of medium power.

For example, the conveyor may have a power of 200 kW to less than 2500 kW single motor power, but the motor power may also be 2500 kW or more, and preferably no more than 10 MW or less. The conveyor may, for example, be operated in an open-cast mine, or an underground mine, for example in pit or overland conveyors. The conveyor may be applied to bulk material handling operations such as stockpiles, material handling terminals or processing plants.

The gearless motor may be a low speed torque motor. Examples of a low speed gearless motor are motors, with a rated speed of 30 to 130 rpm, and preferably not more than 200 rpm. Examples of the type of gearless motor which may be used are permanent magnet type, a synchronous motor type with external excitation, an induction motor type, a liquid cooled motor, or an air cooled motor.

The gearless motor may be an electric motor, and it may include a rotor and a stator. The rotor may be co-rotationally (rigidly) coupled to the motor shaft. The motor may be a permanent-magnet motor, a synchronous motor, or an induction motor.

The housing of the gearless motor includes a mounting section. The mounting section may be positioned at the lower portion of the motor. For example, the feet may be in the lower half of the motor frame, and/or may be raisable up to the horizontal shaft symmetry axis. In other words, the feet may be raised up to the height of the motor shaft. The mounting section may comprise at least one foot. Any number of feet may be used, but 3 or 4 feet are preferable. A height adjustment member, for example one or more shim plates, may be provided below each foot.

The base frame supports the motor. The base frame may be made of a material such as steel or the like. A platform or surface of the base frame which supports the motor may be disposed essentially horizontally (e.g, with a deviation of less than 15° from the horizontal plane).

Because the frame supports the motor, the pulley shaft and the structures supporting the pulley shaft of the conveyor installation do not require additional reinforcements. Preferably, the pulley shaft supports less than 50%, preferably less than 10%, and more preferably less than 5% of the weight of the gearless motor, or a total weight of the gearless motor and the base frame. More preferably, the weight of the motor and of the base frame is essentially completely supported by the support structure. Thereby, it is possible to use a coupling which compensates for misalignment between the motor shaft and the pulley shaft, such as a flexible coupling.

The first alignment portion is provided between the mounting section of the gearless motor, and the base frame. The first alignment portion allows adjusting the motor at least vertically relative to the base frame. The first alignment portion may include a height adjustment member. The height adjustment member may allow for adjustment in discrete steps, for example, one or more shims. The shims may be inserted between the mounting section and the base frame for alignment of the motor. Alternatively, the height adjustment member may allow for continuous adjustment, such as a hydraulic adjustment member. In the method of installing the conveyor drive system, an initial height adjustment member allowing for continuous adjustment may be replaced by a discrete height adjustment member such as shims during installation. More generally, the first alignment portion may also include devices such as shims or hydraulic devices, spindles or screws to allow at least vertical, and optionally, horizontal adjustment of the motor.

The first alignment portion may be arranged below the mounting section, preferably directly below the mounting section and/or in direct contact with the mounting section. For example, if the first alignment portion includes four feet, respective shim stacks may be inserted between each of the feet and the base frame, and the number or thickness of shims of each shim stack (for each foot) may differ, to allow vertical adjustment of the motor. Each one of the shim stacks may have at least one shim, which confirms that the shim stacks are not only provided for aligning the feet to each other, but for height adjustment of the motor as a whole.

The first alignment portion may also include a horizontal adjustment member for horizontal adjustment of the motor, such as long holes or sliders arranged in the base frame for horizontally adjusting the positions at which the motor feet are fixated (e.g., screwed) on the base frame.

The base frame is supported by the support structure, which comprises a first support member and a second support member. The support structure may be fixedly mounted to be able to support the base frame with the motor mounted thereon, and to be itself directly or indirectly supported by the ground. For example, the support structure may be fixedly mounted to a conveyor installation frame (which may also—possibly indirectly-support the pulley shaft and possibly other parts of the conveyor), or may be mounted to a foundation on the ground. The first and second support members may be individually or jointly mounted.

The first support member and the second support member are spaced apart from each other in a direction perpendicular to the axial direction of the motor shaft. Thus, a line between the first and second support members (defined as a line between their centers) has at least a component in the direction perpendicular to the axial direction of the motor shaft, but may still be at an angle with that direction. Preferably, the angle is less than 30°.

The first support member may be provided closer to the motor shaft than the second support member in a horizontal direction perpendicular to the motor shaft. In this way, the first support member may support a greater portion of the weight of the gearless motor than the second support member, and/or a (height) adjustment at the first support member may be particularly effective for aligning the motor shaft.

The first support member and/or the second support member may be provided below the base frame, but are not limited to this arrangement. The first support member and/or the second support member could alternatively be provided above the base frame, or at substantially the same height as the base frame. The first support member may support the base frame from below, from a side, or from above, and the second support member, independently of the position of the first support member, may support the base frame from below, from a side, or from above.

The base frame is preferably connected to the support structure by a three-support connection, having no more than three supports (which may be, in an idealized representation, represented as support points) connecting the base frame to the support structure. In a three-support connection, preferably, the three supports are arranged in a triangular layout when viewed from above.

In a three-support connection, the support structure may have two supports at the first support member, and one support at the second support member. In this case, the two first support members are preferably spaced apart in a horizontal direction parallel to the axis of the motor shaft. The base frame may be connected to the first support member via two second alignment portions which provide the two supports, and connected to the second support by the connecting portion which provides one support.

In particular, two supports of the three-point support may connect the base frame to the first support member. More specifically, two supports of the three-point support may connect to the first support member by the second alignment portions. One support of the three-support connection may connect the base frame to the second support by the connecting portion. The three-support configuration may advantageously support the base frame in a simple, easily and rapidly aligned manner without risk of mismatch or instability, in the same manner that a table having three legs is particularly stable.

The support structure, including the first support member and the second support member, may be made of steel, such as steel beams, and/or concrete.

The second alignment portion is provided between the first support and the base frame, and allows adjustment of the base frame relative to the first support. The second alignment portion may include a height adjustment member, for example, one or more shims. The shims may be inserted between the first support and the base frame for at least vertical alignment of the base frame. The second alignment portion may be arranged below the base frame. The second alignment portion may also include a horizontal adjustment member, for example long holes or a slider.

Preferably, the second alignment portion can provide coarse adjustment and the first alignment portion can provide fine adjustment. For example, the first alignment portion may use shims which are no thicker, and preferably thinner shims, than the second alignment portion, and/or may have a smaller range of vertical adjustment than the second alignment portion. By providing a coarse alignment as well as a fine alignment at least in the vertical direction, it becomes possible to easily and rapidly obtain accurate alignment. In particular, it becomes possible to rapidly and accurately align the axis of the motor shaft coaxially with the axis of the pulley shaft.

The connecting portion connects the base frame to the second support. The connecting portion may be a fixed connection. The fixed connection may be a bolted connection. The fixed connection preferably provides a fixed connection between the first support member (41) and the base frame (10).

Alternatively, the connecting portion may be a pivot connection with at least one degree of freedom. The pivot may preferably have a pivot axis parallel to the axis of the motor shaft or pulley shaft, and/or perpendicular (in a right-angle (or at any angle) to the pulley shaft) to allow movement in a horizontal direction of the base frame relative to the second support. The pivot may also be adjustable in a horizontal direction, to allow positioning in a horizontal direction of the base frame relative to the second support for installation. For example, the connecting portion may be a universal joint, cardan joint, hinge bearing, plain bearing, spherical bearing, or the like.

The coupling is provided to gearlessly couple the motor shaft to the pulley shaft. The coupling can compensate for any misalignments between the motor shaft and the pulley shaft. For example, such misalignments may be residual misalignments, e.g., associated with smaller tolerances or misalignments than the fine adjustment provided by the first alignment portion. Such residual misalignments may also arise during operation of the conveyor belt, due to the load carried by the conveyor belt, the torque applied to the pulley shaft, thermal expansion, and/or the like.

The misalignment may thus be referred to as a residual misalignment, such as a misalignment remaining after the conveyor drive system has been installed, and which is smaller than a vertical and/or horizontal adjustment range, or adjustment precision, of the first alignment portion.

The misalignment may be an axial, radial, and/or angular misalignment of the motor shaft with respect to the pulley shaft, and preferably, the coupling can compensate for such axial, radial, and/or angular misalignments.

A coupling which can compensate for misalignments may be, for example a flexible coupling. Preferable types of flexible coupling are gear couplings, steel laminae couplings, flexible jaw couplings, or the like. Other types of couplings which can compensate for misalignments are disc or membrane couplings or servo couplings.

A disc brake may be provided between the gearless motor and pulley. The disc brake may, for example, be integrated with the pulley shaft. The disc brake may comprise a floating brake caliper to compensate for brake disc displacement, and/or the disk brake may comprise a brake stand with a connected brake which is adjustable for alignment with the brake disk. The adjustment of the floating brake caliper and/or the brake stand with connected brake may be in the vertical and/or horizontal directions.

In addition to the gearless motor, a liquid cooler unit (CU) and other devices may be installed on the base frame.

When installing the conveyor drive system in an industrial conveyor installation, the conveyor drive system may be installed with the support structure stably supported (possibly indirectly) by the ground. This may for example be achieved by mounting the support structure to a conveyor installation frame of the conveyor installation.

Then, the base frame, with the motor mounted thereon, may be positioned in alignment with the first support member and connected to the second support member. For example, a crane may be used to position and temporarily support the base frame carrying the motor, while the base frame is connected to the second support member. Then, the base frame may be mounted to the first support member via the second alignment portion, whereby the second alignment portion is adjusted (e.g., by inserting an appropriate shim plate stack) for coarse alignment of the motor shaft (22) with the pulley shaft (2). Thereafter, the crane may be uncoupled and removed.

After the second alignment portion has been adjusted, the first alignment portion is adjusted for fine alignment of the motor shaft with the pulley shaft. The adjustment may be performed by providing appropriate shim plate stacks.

In a particular example, an initial first adjustment member may be provided (e.g., pre-installed) between the mounting section of the motor and the base frame for adjusting the motor relative to the base frame. The initial first adjustment member may allow for continuous (vertical and optionally also horizontal) adjustment, and may for example include a hydraulic adjustment system. The initial first alignment member may be adjusted for fine alignment of the motor shaft with the pulley shaft. Then, the initial first alignment member may be replaced by a permanent first alignment member such as a discrete height adjustment member (e.g., respective shim plate stacks), whereby the height of the permanent first alignment member is selected to match the height provided by the initial first alignment member.

After the first alignment portion has been adjusted in this manner, the motor shaft may be coupled to the pulley shaft by the (flexible) coupling.

### DRAWINGS

FIG. 1 is a schematic side view showing components of an aspect of the conveyor drive system.

FIG. 2 is a schematic top view of the aspect of the conveyor drive system.

FIG. 3 is a perspective view showing a support structure including the first and second support members of the conveyor drive system.

### EMBODIMENTS OF INVENTION

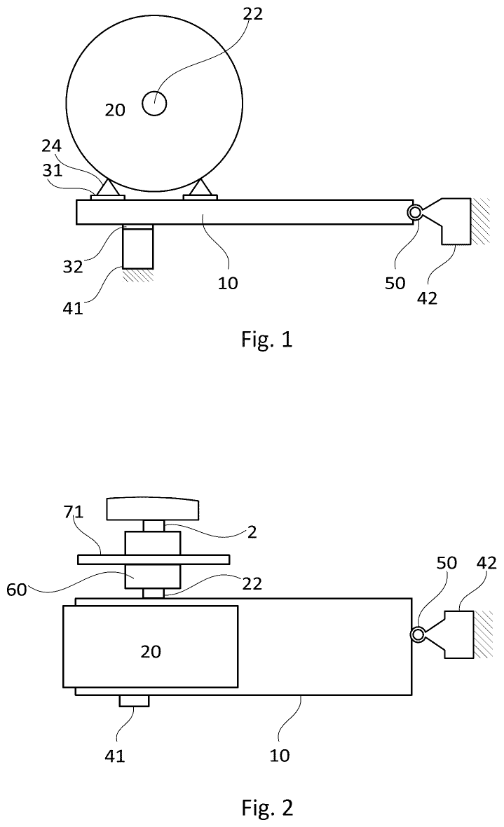

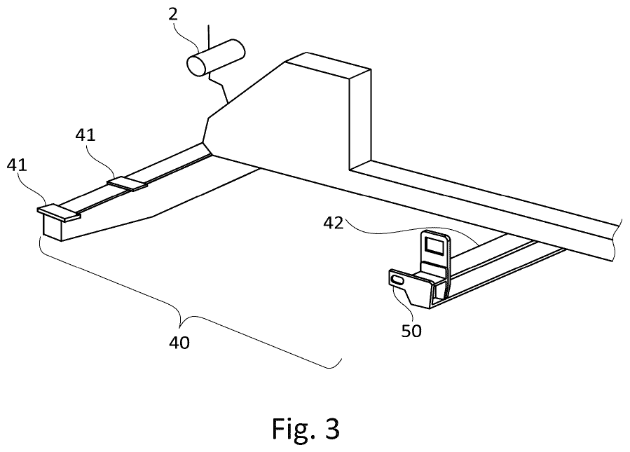

As shown in FIG. 1, a base frame (10) is provided for supporting the gearless motor (20). Near one end of the base frame (10), and below the base frame (10), two first supports (41) are provided, spaced apart in a direction parallel to the axis of the motor shaft (22). A configuration of two first supports (41) spaced apart in a direction parallel to the axis of the motor shaft (22) is shown in perspective in FIG. 3.

A second alignment portion (32) is provided between each of the first supports (41) and the base frame (10). These second alignment portions (32) include shims which are inserted between the first supports (41) and the base frame (10), to provide coarse alignment of the base frame (10) at least vertically. In this way, the alignment portions (32) can provide coarse vertical horizontal alignment the motor shaft (22) with the pulley shaft (2). The number or thickness of the shims of each second alignment portion (32) may be different, to provide better alignment of the motor shaft (22) towards the pulley shaft (2). Optionally, a horizontal alignment means, such as jacking bolts or the like, may also be provided at the alignment portions (32) for horizontal alignment of the base frame (10).

At the other end of the base frame (10), the connecting portion (50) is provided to connect the base frame (10) to the second support (42). As shown in FIG. 1, the connecting portion (50) is a pivot connection.

In this way, the two first supports (41) and the connecting portion (50) form a three-support connection between the base frame (10) and the support structure (40). The pivot can follow the adjustments made by the second alignment portions (32) while supporting one end of the base frame (10). This provides a simple structure which can achieve relatively easy and fast alignment of the base frame (10). As a result, fast and easy coarse alignment of the motor shaft (22) and the pulley shaft (2) can be achieved when installing the conveyor drive system.

The housing of the gearless motor (20) includes the mounting section (24) comprising four feet (only the two feet closer to the viewer are shown). A first alignment portion (31) is provided between each of the feet, and the base frame (10). The first alignment portions (31) can provide fine adjustment of the gearless motor (20), so that the motor shaft (22) can be finely coaxially aligned to the pulley shaft (2).

The coupling (60) is a flexible coupling which can compensate for misalignments between the motor shaft (22) and the pulley shaft (2). Such misalignments may arise during operation of the conveyor, for example, due to the load carried by the conveyor, the tension of the conveyor belt, the torque applied to the conveyor, or the like. Alignments may also arise due to thermal expansion/contraction of the conveyor installation or the like. The flexible coupling allows the operation of the conveyor despite such misalignments.

As shown in FIG. 2, the conveyor drive system may also be provided with a disc brake, having a brake disc (71), between the gearless motor (20) and the pulley shaft (2). The disc brake of this embodiment includes a floating brake caliper (not shown) to compensate for displacements of the brake disc (71).

When installing the conveyor drive system of this embodiment in an industrial conveyor installation, first, the support structure (40) including the first supports (41) and second support (42) are mounted to the conveyor installation frame. Then, the base frame (10), with the motor (20) mounted thereon, is positioned above the first support (41), and the base frame (10) is connected to the second support (42) by the connecting portion (50).

As shown in FIG. 3, the connecting portion (50) is a pivot connection which includes a slit which receives a bolt, such that the bolt has its axis parallel to the axis of the motor shaft (22), to connect the base frame (10) to the second support (42). In this way, the base frame (10) can pivot along the axis of the bolt, and can also move horizontally in the lengthwise direction of the slit, to follow the alignment of the second alignment portion (32) in the next step.

Then, the second alignment portions (32) are adjusted by inserting shims, for coarse alignment of the motor shaft (22) with the pulley shaft (2), and the base frame (10) is mounted on the first support (41).

Then, fine alignment is carried out by adjusting the first alignment portion (31) for fine alignment of the motor shaft (22) with the pulley shaft (2), so that the motor shaft (22) is coaxial with the pulley shaft (2), and the motor shaft (22) is coupled to the pulley shaft (2) by the flexible coupling (60).

This provides the advantages that the base frame needs to be shimmed in only the two positions of the second alignment portions (32). The pivot connection of the connecting portion (50) allows rotational movement in the pivot point which reduces the number of shim connections to the two second alignment portions (32). This three-support arrangement provides easier alignment than, for example, a four-support alignment with two first support connections and two second support connections.

By providing both the first alignment portion (31) and the second alignment portion (32), it is possible to easily and rapidly align and install the base frame (10). After the mounting of the base frame (10) has been achieved, the fine adjustment of the motor shaft (22) to the pulley shaft (2) can be carried out.

In this way, it is possible to achieve easy and rapid installation of a conveyor drive system (1) including a gearless motor (20) without major modification of an existing conveyor installation.

### REFERENCE SYMBOLS

1 conveyor drive system
2 pulley shaft
10 base frame
20 gearless motor
22 motor shaft
24 mounting section
31 first alignment portion
32 second alignment portion
40 support structure
41 first support
42 second support
50 connecting portion
60 coupling
71 brake disc

1. A conveyor drive system for an industrial conveyor installation, the conveyor drive system comprising:
a pulley shaft configured to drive a conveyor belt of the conveyor installation;
a gearless motor for gearlessly driving the pulley shaft, the motor including a motor shaft and a motor housing having a mounting section;
a base frame for supporting the motor;
a first alignment portion, wherein the motor is mounted with its mounting section on the base frame, the first alignment portion being provided between the mounting section and the base frame for adjusting the motor at least vertically relative to the base frame;
a support structure configured for supporting the base frame, the support structure including a first support member and a second support member, the first support member and the second support member being spaced apart from each other in a direction perpendicular to an axial direction of the motor shaft;
a second alignment portion being provided between the first support member and the base frame for adjusting the base frame at least vertically relative to the first support member;
a connecting portion connecting the base frame to the second support member; and
a coupling gearlessly coupling the motor shaft to the pulley shaft, and compensating for misalignment between the motor shaft and the pulley shaft.

2. The conveyor drive system according to claim 1, wherein the first and second alignment portions are adjusted for aligning the motor shaft coaxially with the pulley shaft, and optionally,
wherein the second alignment portion is configured to provide coarse adjustment and the first alignment portion is configured to provide fine adjustment, and/or a vertical adjustment range of the second alignment portion is larger than a vertical adjustment range of the first alignment portion.

3. The conveyor drive system according to claim 1, wherein the first alignment portion is arranged below the mounting section and the second alignment portion is arranged below the base frame.

4. The conveyor drive system according to claim 1, wherein the first support member is closer to the motor shaft than the second support member in a horizontal direction perpendicular to the motor shaft.

5. The conveyor drive system according to claim 1, wherein the mounting section comprises at least one foot, preferably at least three feet, and more preferably four feet, and wherein the first alignment portion includes a height adjustment member, preferably a shim, provided below each of the at least one foot.

6. The conveyor drive system according to claim 1, wherein the connecting portion is a fixed connection, preferably a bolted connection.

7. The conveyor drive system according to claim 1, wherein the connecting portion is a pivot connection with at least one degree of freedom, and optionally, is also adjustable in a horizontal direction, and optionally,
the pivot has a pivot axis parallel to an axis of the motor shaft or the pulley shaft.

8. The conveyor drive system according to claim 1, wherein the pulley shaft supports less than 50%, preferably less than 10%, and more preferably less than 5% of a weight of the motor or a total weight of the motor and the base frame.

9. The conveyor drive system according to claim 1, wherein the coupling is a flexible coupling.

10. The conveyor drive system according to claim 1, wherein the first alignment portion and/or the second alignment portion includes shims.

11. The conveyor drive system according to claim 1, wherein the first support member comprises two first support members spaced apart from each other in a direction parallel to the axis of the motor shaft.

12. The conveyor drive system according to claim 11, wherein the base frame is connected to the support structure by a three-support connection, having no more than three supports connecting the base frame and the support structure, and/or
wherein the base frame is connected to the first support member by the second alignment portion providing two support connections, and to the second support by the connecting portion providing one support connection.

13. The conveyor drive system according to claim 1, further comprising a disk brake provided between the gearless motor and the pulley shaft,
wherein the disc brake includes a floating brake caliper configured to compensate for displacement of a brake disk, and/or wherein the disk brake includes a brake stand with a connected brake which is [horizontally] adjustable for alignment with the brake disk.

14. The conveyor drive system according to claim 1, wherein the motor is at least one of a permanent magnet type and a synchronous motor type with external excitation, and an induction motor type, and wherein the motor is preferably liquid-cooled or air-cooled.

15. The conveyor drive system according to claim 1, wherein the first support member and/or the second support member are made of steel beams, and/or concrete.

16. The conveyor drive system according to claim 1, wherein the coupling is a straight coupling so that the axis of the motor shaft and the axis of the pulley shaft are concentric to each other.

17. An industrial conveyor installation comprising a conveyor belt; and a conveyor drive system, the conveyor drive system including:
a pulley shaft configured to drive a conveyor belt of the conveyor installation;
a gearless motor for gearlessly driving the pulley shaft, the motor including a motor shaft and a motor housing having a mounting section;
a base frame for supporting the motor;
a first alignment portion, wherein the motor is mounted with its mounting section on the base frame, the first alignment portion being provided between the mounting section and the base frame for adjusting the motor at least vertically relative to the base frame;
a support structure configured for supporting the base frame, the support structure including a first support member and a second support member, the first support member and the second support member being spaced apart from each other in a direction perpendicular to an axial direction of the motor shaft;
a second alignment portion being provided between the first support member and the base frame for adjusting the base frame at least vertically relative to the first support member;
a connecting portion connecting the base frame to the second support member; and
a coupling gearlessly coupling the motor shaft to the pulley shaft, and compensating for misalignment between the motor shaft and the pulley shaft for driving the conveyor belt via the pulley shaft.

18. The industrial conveyor installation according to claim 17, further comprising a rigid conveyor installation frame of the conveyor installation for supporting the pulley shaft,
wherein the support structure is mounted to and supported by the conveyor installation frame.

19. A method of installing a conveyor drive system for an industrial conveyor installation, the conveyor drive system including:
a pulley shaft configured to drive a conveyor belt of the conveyor installation;
a gearless motor for gearlessly driving the pulley shaft, the motor including a motor shaft and a motor housing having a mounting section;
a base frame for supporting the motor;
a first alignment portion, wherein the motor is mounted with its mounting section on the base frame, the first alignment portion being provided between the mounting section and the base frame for adjusting the motor at least vertically relative to the base frame;
a support structure configured for supporting the base frame, the support structure including a first support member and a second support member, the first support member and the second support member being spaced apart from each other in a direction perpendicular to an axial direction of the motor shaft;
a second alignment portion being provided between the first support member and the base frame for adjusting the base frame at least vertically relative to the first support member;
a connecting portion connecting the base frame to the second support member; and
a coupling gearlessly coupling the motor shaft to the pulley shaft, and compensating for misalignment between the motor shaft and the pulley shaft in an industrial conveyor installation, the method comprising the steps of:
a. mounting the support structure including the first support member and the second support member to a conveyor installation frame of the conveyor installation;
b. positioning the base frame, with the motor mounted thereon, in alignment with the first support member and connecting the base frame to the second support member by the connecting portion;
c. adjusting the second alignment portion for coarse alignment of the motor shaft with the pulley shaft, and mounting the base frame to the first support member via the second alignment portion;
d. adjusting the first alignment portion for fine alignment of the motor shaft with the pulley shaft; and
e. coupling the motor shaft to the pulley shaft by the coupling.
